(19) United States
(12) Patent Application Publication
(10) Pub. No.: US 2007/0258085 A1
(43) Pub. Date: Nov. 8, 2007

(54) Substrate illumination and inspection system

(76) Inventors: Michael D. Robbins, Round Rock, TX (US); Paul F. Forderhase, Austin, TX (US); Joel B. Bailey, Austin, TX (US); Kevin Nguyen, Leander, TX (US)

Correspondence Address: HARNESS, DICKEY & PIERCE, P.L.C., P.O. BOX 828, BLOOMFIELD HILLS, MI, 48303, US

(21) Appl. No.: 11/417,297

(22) Filed: May 2, 2006

(51) Int. Cl. G01N 21/00

(52) U.S. Cl. 356/237.4

(57) ABSTRACT

A substrate illumination and inspection system provides for illuminating and inspecting a substrate particularly the substrate edge. The system uses a light diffuser with a plurality of lights disposed at its exterior or interior for providing uniform diffuse illumination of a substrate. An optic and imaging system exterior of the light diffuser are used to inspect the plurality of surfaces of the substrate including specular surfaces. The optic is held at an angle from a surface normal to avoid reflective artifacts from the specular surface of the substrate. The optic can be rotated radially relative to a center point of the substrate edge to allow for focused inspection of all surfaces of the substrate edge. The plurality of lights can modulate color and intensity of light to enhance inspection of the substrate for defects.

### FIELD

The present disclosure relates to illumination and inspection of a substrate, particularly illumination and inspection of specular surfaces of a silicon wafer edge with diffuse light from a plurality of light sources for enhanced viewing of the wafer edge.

### BACKGROUND

The statements in this section merely provide background information related to the present disclosure and may not constitute prior art.

Substrate processing, particularly silicon wafer processing involves deposition and etching of films and other processes at various stages in the eventual manufacture of integrated circuits. Because of this processing, contaminants, particles, and other defects develop in the edge area of the wafer. This includes particles, contaminants and other defects such as chips, cracks or delamination that develop on edge exclusion zones (near edge top surface and near edge back surface), and edge (including top bevel, crown and bottom bevel) of the wafer. It has been shown that a significant percentage of yield loss, in terms of final integrated circuits, results from particulate contamination originating from the edge area of the wafer causing killer defects inside the FQA (fixed quality area) portion of the wafer. See for example, Braun, The Wafer's Edge, Semiconductor International (Mar. 1, 2006), for a discussion of defects and wafer edge inspection methodologies.

Attempts at high magnification inspection of this region of the wafer have been confounded by poor illumination of these surfaces. It is difficult to properly illuminate and inspect the edge area of an in-process wafer. An in-process wafer typically has a reflective specular (“mirror”) surface. Attempts at illuminating this surface from a surface normal position frequently results in viewing reflections of surrounding environment of the wafer edge thus making it difficult to visualize defects or distinguish the defects from reflective artifact. Further, the wafer edge area has a plurality of specular surfaces extending from the near edge top surface across the top bevel, the crown, the bottom bevel to the near edge bottom surface. These too cause non-uniform reflection of light necessary for viewing the wafer edge area and defect inspection. In addition, color fidelity to observed films and contrast of lighting are important considerations for any wafer edge inspection system.

Therefore, there is a need for a system that adequately illuminates the edge area of a wafer for inspection. It is important that the system provide for illumination and viewing suitable for a highly reflective surface extending over a plurality of surfaces and for a variety of defects to be observed. The system must provide for efficient and effective inspection of the edge area for a variety of defects.

### SUMMARY

Further areas of applicability will become apparent from the description provided herein. It should be understood that the description and specific examples are intended for purposes of illustration only and are not intended to limit the scope of the present disclosure.

In accordance with the present disclosure, a substrate illumination system has a light diffuser with an opening extending at least a portion of its length for receiving an edge of a wafer. The system also comprises a plurality of light sources in proximity to the light diffuser. The system further comprises an optic for viewing the wafer wherein the optic is exterior of the light diffuser and is angled off of the wafer edge surface normal position.

In an additional aspect, the system comprises an illumination control system for independently controlling the plurality of light sources. Individually or by groups or sections, the plurality of lights can be dimmed or brightened. In addition, the plurality of lights can change color, individually or by groups or sections. Yet another aspect of the system comprises a rotation mechanism for rotating the optic from a position facing the top of the wafer to a position facing the bottom of the wafer. In an additional aspect of the system, the plurality of light sources is an LED matrix or alternatively a flexible OLED or LCD. In this aspect the flexible OLED or LCD can act in place of the plurality of lights or in place of both the light diffuser and the plurality of lights. The light sources can also be one or more halogen lamps. The one or more halogen lamps can be coupled to an array of fiber optics.

In yet an additional aspect, the system comprises a method for imaging the specular surface of a substrate. This method comprises, isolating a portion of the substrate in a light diffuser, emitting light onto the specular surface to be imaged and imaging the specular surface with an optic positioned at an angle off the specular surface normal from a position exterior to the light emitter.

### DRAWINGS

The drawings described herein are for illustration purposes only and are not intended to limit the scope of the present disclosure in any way.

FIG. 1 shows a schematic top view of the substrate illumination system of the present disclosure;

FIG. 2 shows a schematic side view of the system as shown in FIG. 1;

FIG. 3 shows a detailed view of a portion of the view shown in FIG. 2;

FIG. 4 shows a schematic side view of an alternative embodiment of the substrate illumination system;

FIG. 5 shows a detailed view of a portion of the view shown in FIG. 4;

FIG. 6 shows a schematic side view of another alternative embodiment of the substrate illumination system;

FIG. 7 shows a perspective view of yet another embodiment of the substrate illumination system; and

FIG. 8 shows a top plan view of the alternative embodiment of the substrate illumination system as shown in FIG. 7.

### DETAILED DESCRIPTION

The following description is merely exemplary in nature and is not intended to limit the present disclosure, application, or uses. It should be understood that throughout the drawings, corresponding reference numerals indicate like or corresponding parts and features.

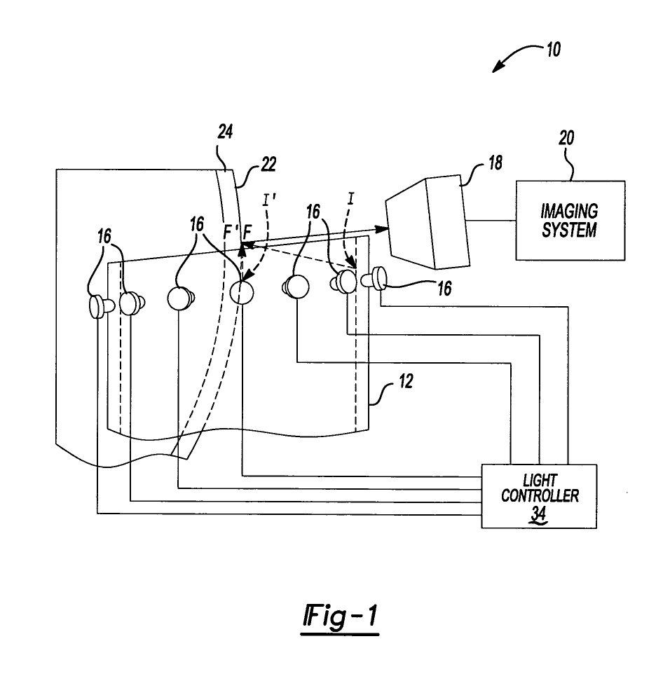

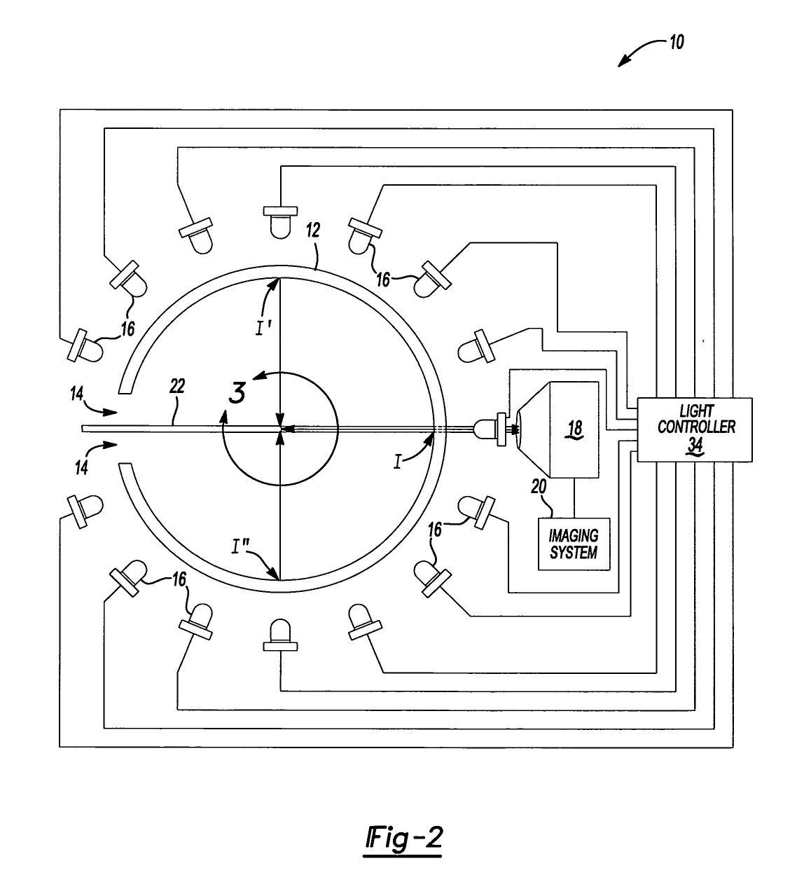

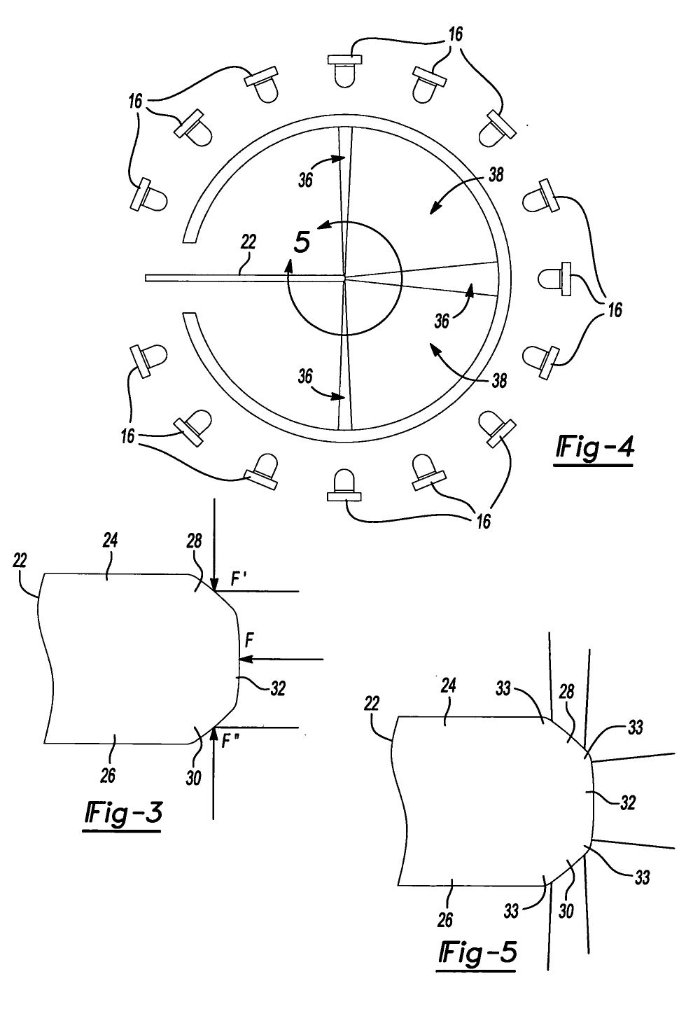

Referring to FIGS. 1, 2, and 3 a substrate illumination system 10 (the “System”) of the disclosure has a diffuser 12 with a slot 14 along its length and a plurality of lights 16 surrounding its exterior radial periphery. Exterior of the diffuser 12 is an optic 18 that is connected to an imaging system 20 for viewing a substrate 22 as the substrate is held within the slot 14. The plurality of lights 16 are connected to a light controller 34.

The System 10 can be used to uniformly illuminate for brightfield inspection of all surfaces of an edge area of the substrate 22 including, a near edge top surface 24, a near edge bottom surface 26, a top bevel 28, a bottom bevel 30 and a crown 32.

The optic 18 is a lens or combination of lenses, prisms, and related optical hardware. The optic 18 is aimed at the substrate 22 at an angle off a surface normal to the crown 32 of the substrate 22. The angle of the optic 18 advantageously allows for preventing a specular surface of the substrate 22 from reflecting back the optic 18 whereby the optic 18 “sees itself.” The viewing angle is typically 3 to 6 degrees off normal. Some optimization outside of this range is possible depending on illuminator alignment relative to the substrate 22 and the specific optic 18 configuration.

The imaging system 20 is for example a charge-coupled device (CCD) camera suitable for microscopic imaging. The imaging system 20 may be connected to a display monitor and/or computer (not shown) for viewing, analyzing, and storing images of the substrate 22.

Diffuser 12 is formed of a translucent material suitable for providing uniform diffuse illumination. The diffuser 12 may be formed of a frosted glass, a sand blasted quartz or a plastic or the like, where light passing through it is uniformly diffused. In a preferred embodiment, the diffuser 12 is a circular cylinder as illustrated. Diffuser 12 may be an elliptic cylinder, generalized cylinder, or other shape that allows for surrounding and isolating a portion of a substrate 22 including the substrate 22 edge. The slot 14 in the diffuser 12 extends for a suitable length to allow introduction of the substrate 22 into the diffuser 12 far enough to provide uniform illumination of the edge area and to isolate the edge area from the outside of the diffuser 12.

Importantly, the interior of the diffuser 12 serves as a uniform neutral background for any reflection from the specular surface of the substrate 22 that is captured by the optic 18. Thus, the optic 18 while looking towards focal point F on the specular surface of the crown 32 images (sees) the interior of the diffuser 12 at location I. Similarly, the optic 18 looking towards focal points F′ and F″ on the specular surfaces of the top bevel 28 and bottom bevel 30 respectively, images the interior of the diffuser 12 at locations I′ and I″.

The angle of the optic 18 in cooperation with the diffuser 12 prevents reflective artifacts from interfering with viewing the plurality of specular surfaces of the edge area of the substrate 22. Instead, and advantageously, a uniform background of the diffuser 12 interior is seen in the reflection of the specular surfaces of the substrate 22.

The plurality of lights 16 is a highly incoherent light source including an incandescent light. In a preferred embodiment, the plurality of lights 16 is an array of LEDs. Alternatively, a quartz halogen bulb can be the light source with fiber optics (not shown) used to distribute light of this single light source radially around the diffuser 12. In another preferred embodiment the plurality of lights 16 is an array of fiber optics each coupled to an independent, remotely located quartz tungsten halogen (QTH) lamp.

The plurality of lights 16 is preferably a white light source to provide the best color fidelity. In substrate 22 observation, color fidelity is important because of film thickness information conveyed by thin film interference colors. If the substrate 22 surface is illuminated with light having some spectral bias, the thin film interference information can be distorted. Slight amounts of spectral bias in the light source can be accommodated by using filters and/or electronic adjustment (i.e., camera white balance).

In operation, a substrate 22, for example, a wafer is placed on a rotatable chuck (not shown) that moves the edge of the wafer into the slot 14 of the diffuser 12. The light controller 34 activates in suitable brightness the plurality of lights 16 for providing uniform illumination of the edge area of the wafer. The wafer is viewed through the imaging system 20 via the optic 18 and inspected for defects. The wafer may be automatically rotated or manually rotated to allow for selective viewing of the wafer edge. Thus, observation of the wafer edge for defects is facilitated and is unhindered by a specular surface of the wafer.

With added reference to FIGS. 4 and 5, in an embodiment of the System 10 the plurality of lights 16 are individually controlled by the light controller 34. In this embodiment light controller 34 is a dimmer/switch suitable for dimming individually or in groups a plurality of lights. Alternatively, light controller 34 can be the type as disclosed in U.S. Pat. Nos. 6,369,524 or 5,629,607, incorporated herein by reference. Light controller 34 provides for dimming and brightening or alternatively turning on/off individually or in groups each of the lights in the plurality of lights 16.

The intensity of a portion of the plurality of lights 16 is dimmed or brightened to anticipate the reflective effect of specular surfaces that are inherent to the substrate 22, particularly at micro locations along the edge profile that have very small radii of curvature. These micro locations are the transition zones 33 where the top surface 24 meets the top bevel 28 and the top bevel meets the crown 32 and the crown meets the bottom bevel 30 and the bottom bevel 30 meets the bottom surface 26.

An example of addressable illumination is illustrated in FIGS. 4 and 5 where higher intensity illumination 36 is directed to a top bevel 28, crown 32 and bottom bevel 30 while lower intensity illumination 38 is directed to the transition zones 33 in between. With this illumination configuration, the image of these transition zones 33 are seen illuminated with similar intensity as compared to the top bevel 28, crown 32 and bottom bevel 30.

Further, addressable illumination is useful to accommodate intensity variation seen by the optic 18 due to view factor of the substrate 22 edge area. Some portions of the substrate 22 edge area have a high view factor with respect to the illumination from the diffuser 12 and consequently appear relatively bright. Other portions with low view factor appear relatively dark. Addressable illumination allows mapping an intensity profile onto the wafer surface that allows for the view factor variation and provides a uniformly illuminated image. The required intensity profile can change with viewing angle change of the optic 18.

Addressability of the illumination or its intensity can be accomplished in a number of ways. One embodiment is to locate independently controllable light-emitting diodes (LEDs) around the outside of the diffuser 12 consistent with the plurality of lights 16. Another alternative is to employ a small flexible organic light-emitting diode (OLED), liquid crystal display (LCD) or other micro-display module. Such modules are addressable to a much greater degree than an LED matrix. In this embodiment the flexible OLED, LCD or other micro-display module can replace both the plurality of lights 16 and the diffuser 12. For example, a flexible OLED can both illuminate and have a surface layer with a matte finish suitable for acting as a diffuser and neutral background for imaging. Further, the flexible OLED can be formed into a suitable shape such as a cylinder. Examples of a suitable OLED are disclosed in U.S. Pat. Nos. 7,019,717 and 7,005,671, incorporated herein by reference.

Further, those modules can also provide programmable illumination across a broad range of colors including white light. Color selection can be used to highlight different thin films and can be used in combination with part of an OLED, for example, emitting one color while another part of the OLED emits another color of light. In some cases it can be beneficial to use only part of the light spectrum, for example, to gain sensitivity to a film residue in a given thickness range. This is one mode of analysis particularly applicable to automatic defect classification. One analysis technique to detect backside etch polymer residue preferentially looks at light reflected in the green portion of the spectrum. Thus, this embodiment of the System 10 provides for a suitable color differential based inspection of the substrate 22.

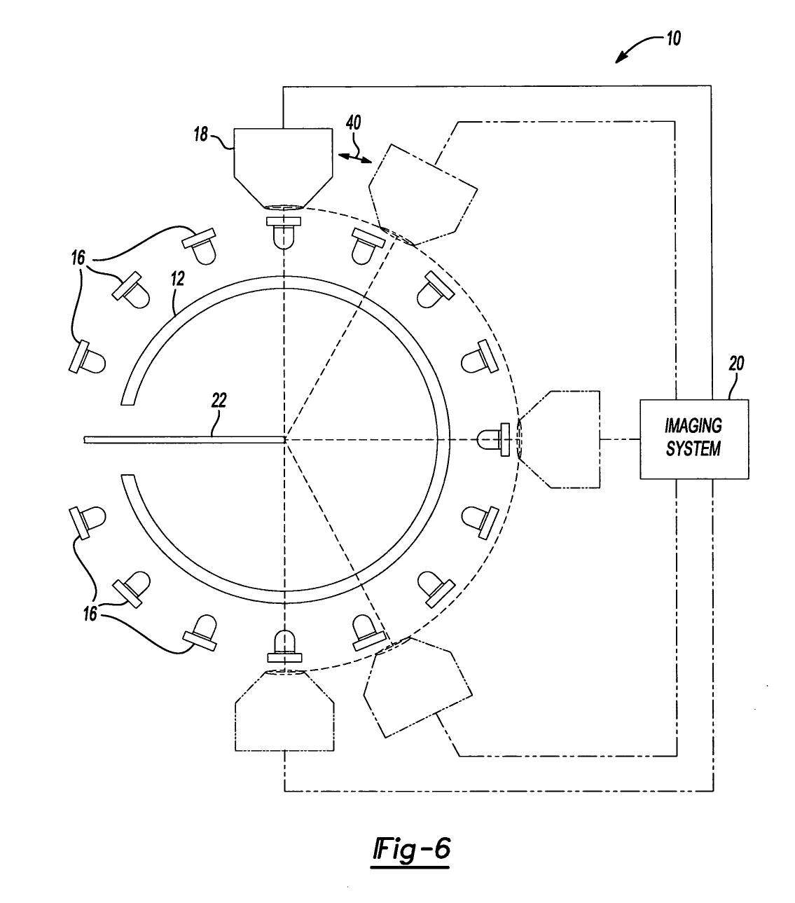

Now referring to FIG. 6, in another embodiment of the System 10, the optic 18 is rotatable in a radial direction 40 around the substrate 22 at a maintained distance from a center point of the substrate 22 edge. The optic 18 is rotatable while maintaining the angle of the optic 18 relative to surface normal of the substrate 22 edge. This allows for focused imaging of all regions of the substrate 22 surface, including the top surface 24, bottom surface 26, top bevel 28, bottom bevel 30 and crown 32. The rotating optic 18 can also include the imaging system 20 or consist of a lens and a CCD camera combination or can be a subset of this consisting of moving mirrors and prisms. This embodiment provides the additional advantage of using one set of camera hardware to view the substrate 22 rather than an array of cameras.

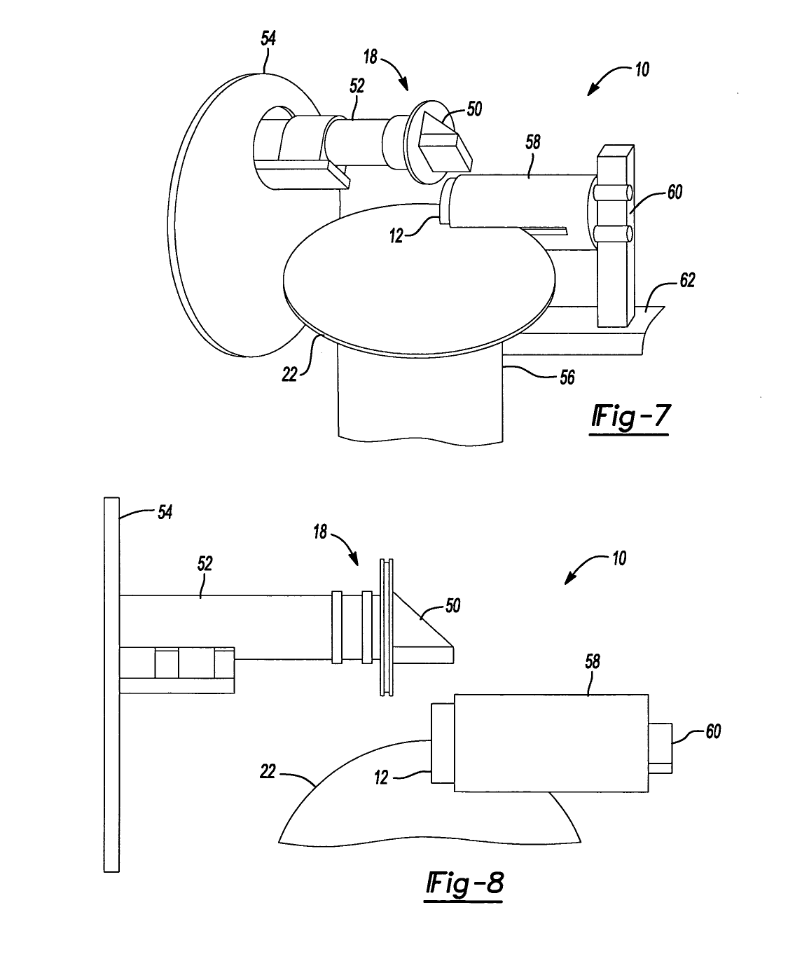

Now referring to FIGS. 7 and 8, in another embodiment of the System 10, the optic 18 includes a fold mirror 50 and a zoom lens assembly 52. The optic 18 is connected to a rotatable armature 54 for rotating the optic 18 radially around the edge of the substrate 22 (as similarly discussed in relation to FIG. 6). The substrate 22 is retained on a rotatable chuck 56. The diffuser 12 is housed in an Illumination cylinder 58 that is retained on a support member 60 connected to a support stand 62.

The operation of this embodiment of the System 10 is substantially the same as described above with the additional functionality of radially moving the optic 18 to further aid in inspecting all surfaces of the edge of the substrate 22. Further, the substrate 22 can be rotated either manually or automatically by the rotatable chuck 56 to facilitate the inspection process.

It should be appreciated that while the embodiments of the System 10 are described in relation to a manual system, an automated system would also be suitable. This includes automated inspection with automated defect classification. This also includes automated inspection in conjunction with automated wafer handling including robotic wafer handling with wafers delivered via FOUP or FOSB.

Thus, a cost effective yet efficient and effective system is provided for illuminating and inspecting the plurality of surfaces of the edge area of a substrate 22 and providing high quality imaging of the inspected surfaces while avoiding the interference associated with specular surfaces. The system provides for improving quality control of wafer processing through edge inspection with the intended benefit of identifying and addressing defects and their causes in the IC manufacturing process with resulting improvement in yield and throughput.

What is claimed is:

1. A wafer edge illumination and inspection system comprising:
a light diffuser having a slit extending at least a portion of its length for receiving a portion of a wafer including a portion of the wafer edge;
a plurality of light sources in proximity to the light diffuser; and
an optic for viewing the wafer wherein the optic is exterior of the light diffuser, and is positioned at an angle off the wafer edge surface normal.

2. The wafer edge illumination and inspection system of claim 1 further comprising:
an illumination control system for independently controlling the plurality of light sources.

3. The wafer edge illumination and inspection system of claim 1 further comprising:
a rotation mechanism for rotating the optic radially relative to a center point of the wafer edge region.

4. The wafer edge illumination and inspection system of claim 1, wherein the light diffuser is a quartz tube.

5. The wafer edge illumination and inspection system of claim 1, wherein the plurality of light sources is an LED matrix.

6. The LED matrix of claim 5 wherein each LED is independently controllable.

7. The wafer edge illumination and inspection system of claim 1, wherein the plurality of light sources is an array of fiber optics each coupled to an independent remotely located lamp.

8. The array of fiber optics of claim 7 wherein each lamp is independently controllable.

9. The wafer edge illumination and inspection system of claim 1, wherein the plurality of light sources is an LCD matrix.

10. The wafer edge illumination and inspection system of claim 1, wherein the plurality of light sources is a flexible OLED.

11. A wafer edge illumination system comprising:
a light source having a slit extending at least a portion of its length for receiving a portion of an edge of a wafer wherein the light source emits a light; and
an illumination control system for controlling location and brightness of the light emitting from the light source.

12. The wafer edge illumination system of claim 11 wherein the light source comprises a flexible OLED.

13. The wafer edge illumination system of claim 11 wherein the light source comprises an LCD display.

14. The wafer edge illumination system of claim 11 further comprising an optic for viewing the wafer wherein the optic is exterior of the light source and is positioned at an angle off the wafer edge surface normal.

15. The wafer edge illumination system of claim 11 wherein the illumination control system further controls the color of the light emitting from the light source.

16. A substrate imaging system for imaging a specular surface of a substrate, comprising:
a light diffuser housing having an opening for receiving a portion of the substrate wherein the interior of the light diffuser housing is a uniform neutral background to a specular surface being imaged wherein the light diffuser housing extends from over a top surface of the wafer to over an edge of the wafer and over a bottom surface of the wafer;
an optical lens angled off a surface normal of the substrate area to be imaged wherein the optical lens is exterior to the light diffuser; and
a light source disposed in the light diffuser housing.

17. The substrate imaging system of claim 16 wherein the light source is coupled to a fiber optic for directing light from the light source to a plurality of locations of the light diffuser housing.

18. The substrate imaging system of claim 16 wherein the light source is one selected from the group of an LED matrix, LCD matrix, and OLED.

19. The substrate imaging system of claim 16 further comprising a light controller for controlling the color and brightness of the light source.

20. The substrate imaging system of claim 16 wherein the light source is one selected from the group of an LED matrix, LCD matrix, and OLED, wherein the light diffuser housing is a covering attached to the light source.

21. A method for imaging specular surfaces of an edge area of a substrate comprising:
isolating a portion of the substrate to be imaged in a light emitter wherein the light emitter wraps around the edge area of the substrate;
emitting light onto the specular surface to be imaged; and
imaging the specular surface with an optic positioned at an angle off the specular surface normal of the edge area from a position exterior to the light emitter.

22. The method for imaging specular surfaces of an edge area of a substrate of claim 21 further comprising:
rotating the substrate and continuing imaging the edge area of the substrate.

23. The method for imaging specular surfaces of an edge area of a substrate of claim 21 further comprising:
controlling the brightness of a portion of the light emitter.

24. The method for imaging specular surfaces of an edge area of a substrate of claim 21 further comprising:
changing the color of the light emitting from the light emitter.

25. The method for imaging specular surfaces of an edge area of a substrate of claim 21 further comprising:
modulating the color of light emitting from the light emitter to detect thin films.
